(19) United States
(12) Patent Application Publication
(10) Pub. No.: US 2021/0396334 A1
(43) Pub. Date: Dec. 23, 2021

(54) PIPELINE FOR CONVEYING FLUIDS OR SOLIDS

(71) Applicant: Lufttechnik Gransee GmbH, Gransee (DE)

(72) Inventor: Rainer MATHO, Berlin (DE)

(73) Assignee: Lufttechnik Gransee GmbH, Gransee (DE)

(21) Appl. No.: 17/351,319

(22) Filed: Jun. 18, 2021

(30) Foreign Application Priority Data
Jun. 19, 2020 (DE) 10 2020 116 217.0

(51) Int. Cl. F16L 9/12; F16L 9/133; F16L 9/02

(52) U.S. Cl. CPC F16L 9/125; F16L 9/02; F16L 9/133

(57) ABSTRACT

A pipeline for conveying fluids or solids has a metallic pipe on which a tubular lining made of plastic is arranged on an inner wall. The wall structure with the lining and the metallic pipe are designed to be electrically conductive and the electrical resistance of the wall structure being less than 10⁸Ω. This allows the electrostatically charged bulk material or fluid to discharge reliably when passing through the pipe.

### CROSS-REFERENCE TO RELATED APPLICATIONS

This application claims priority under 35 USC 119 of German Application No. DE 10 2020 116 217.0, filed on Jun. 19, 2020, the disclosure of which is herein incorporated by reference.

### BACKGROUND OF THE INVENTION

The present invention relates to a pipeline for conveying fluids or solids, comprising a metallic pipe on which a tubular lining of plastic is arranged on an inner wall.

DE 100 24 738 A1 discloses a pipeline in which a tubular glass body is coated with a conductive polymer to reduce surface resistance. Several pipe sections can be joined together to form a single pipe by means of sealants. The use of tubular glass bodies can usually only be used for small pipeline cross-sections. In addition, such a pipe is poorly suited for conveying abrasive bulk materials, as these damage the thin coating.

For conveying bulk materials, it is known that pipelines are equipped with a wear protection layer made of plastic. This allows an abrasive material, such as sand, gravel or grain, to be conveyed through the pipeline, and such pipelines can also be manufactured with a larger cross section. A disadvantage of these pipelines, however, is that a frictional flow can result in an electrostatic charge that affects both the bulk material and the pipeline. A sudden discharge can lead to a danger of ignition of the bulk material and the pipe environment.

### SUMMARY OF THE INVENTION

It is therefore the object of the present invention to provide a pipeline for conveying fluids or solids that is also capable of conveying abrasive materials, while reducing the risk of ignition due to electrostatic charging.

This object is solved according to the invention with a pipeline for conveying fluids or solids having a metallic pipe on which a tubular lining made of plastic is arranged on an inner wall, the wall structure with the lining made of plastic and the metallic pipe being designed to be conductive, and the volume resistivity Rᵥ of the pipeline being less than 10⁸ Ωm according to IEC/TS 60079-32-1:2013. As a result, the risk of ignition in the event of a frictional flow in the pipeline due to electrostatic charge can be reduced, since the charge can be dissipated via the wall structure. The wall structure also provides a high degree of wear protection against abrasive materials due to the plastic lining. An electrostatically charged bulk material or fluid can be reliably discharged when passing through the pipeline.

In the present application, “conductive” means the description of the electrostatic properties or chargeability according to TRGS 727:2016 for solid materials, objects and equipment. This property is divided into conductive, dissipative and insulating (TRGS 727:2016 Annex I). In order for the pipeline with the metallic pipe and the tubular lining made of plastic to be classified as conductive, all individual resistances must be at least in the conductive range.

A pipeline according to the present application may be linear or curved or contain branches. The exact shape of the pipeline can be adapted to the particular application both in the longitudinal direction and in cross-section, the cross-sectional shape preferably being circular.

Preferably, the volume resistivity Rᵥ of the pipeline is between 1.5×10⁶ Ωm and 2.8×10⁶ Ωm, in particular 2.0×10⁶ Ωm and 2.3×10⁶ Ωm. The measurement of the volume resistivity is performed according to IEC 60079-32-2:2015.

The pipeline meets the requirements for dissipative materials as defined by IEC/TS 60079-32-1:2013+AMD1:2017 and TRGS 727:2016. The pipeline is therefore suitable for transporting flammable liquids, flammable gases and pneumatically conveyed flammable dusts, as the dissipative piping can be permanently integrated into the equipotential bonding system. This also eliminates a restriction for bulk conveying by gravity.

The lining preferably comprises polyurethane as the plastic. This material has a high resistance to wear and has sufficient elasticity to compensate for thermal stresses or other deformations. The hardness of the lining can be, for example, between 80 to 86 Shore A. The abrasion loss of the lining according to DIN 53516 is preferably between 35 and 50 mm³, in particular 40 and 46 mm³.

The lining is preferably fixed to the metallic pipe by means of mechanical fasteners made of metal. Screws, nuts, rivets and/or other metallic fasteners can be used as fasteners. Preferably, for a surface area of 1 m², at least 5 fasteners are used to provide sufficient dissipative capability. In addition or alternatively, the lining can also be bonded to the metallic pipe, the adhesive preferably being of conductive design and containing a metallic component, for example silver.

Instead of gluing or fixing via mechanical fasteners, clamping forces or holding forces can be generated by pushing the lining with excess length into the metallic pipe and pressing the two sides against each other. Another method of fixing is compressive stresses, starting from the lining material. This acts with a certain force on the curved inner surface of the pipe so that the lining material is held clamped in the pipe.

The contact pressure of the lining on the metallic pipe can be selected, for example, so that a contact force of between 200N to 400N is present at all measuring points. To measure the contact pressure of the lining, a hole can be made in the shell of the pipe so that a force sensor can be provided on the shell at each hole. The holes are evenly distributed axially and radially in the shell. The shell is then welded to the pipe. The lining is cut with an excess length so that a force in the range of preferably 200 to 400 N can be recorded at all measuring points.

The surface resistivity of the lining according to IEC 60079-32-2:2015, when measured with a ring electrode according to EN ISO 284:2004 at a measuring voltage of 1,000 V, is in a range between 3×10⁷Ω to 90×10⁷Ω, in particular 1×10⁸Ω to 9×10⁸Ω.

Preferably, the plastic lining has a surface resistivity less than 8×0⁸Ω.

The contact resistance Rᵥ according to Din 54345-1:1992 at a measurement voltage of 1,000 V according to IEC 60079-32-2:2015 is preferably between 0.5×10⁷Ω to 15×10⁷Ω.

In a preferred embodiment, an insert made of metal is arranged in the lining. Such an insert can be designed, for example, as a metallic expanded metal mesh. The lining can also be designed without a metallic insert.

The metallic tube is preferably made of steel, in particular a stainless steel, such as chromium-nickel steel, which may optionally be coated.

The diameter of the metallic tube is between 80 mm and 1000 mm, in particular between 100 mm and 400 mm.

### BRIEF DESCRIPTION OF THE DRAWINGS

The invention is explained in more detail below by means of an example of an embodiment with reference to the accompanying drawings, wherein:

FIG. 1 shows a section through a pipeline according to the invention;

FIG. 2 shows a detailed view of the pipeline of FIG. 1.

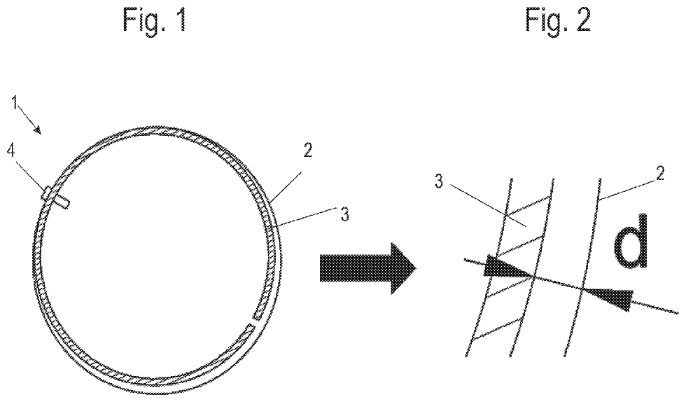

### DETAILED DESCRIPTION OF THE EMBODIMENTS

A pipeline 1 comprises a metallic pipe 2 in which an inner tubular lining 3 made of plastic is arranged. The lining 3 is inserted into the metallic pipe 2 and is clamped to an inner wall of the pipe by a metallic fastening means 4, for example a screw. Several fastening means 4 can be provided distributed over the circumference.

FIG. 2 shows in detail the lining 3 and the pipe 2, which are spaced apart without fastening means and between which a gap (d) is formed which can form a condenser. To avoid such gaps, the lining 3 is preferably in clamping contact with the inner wall of the metallic pipe 2. Alternatively or additionally, the lining 3 can also lie against the metallic pipe 2 in a clamping manner without fastening means 4 or be bonded to the metallic pipe 2, in particular via a conductive adhesive.

According to the invention, the pipeline 1 with the wall structure of lining 3 and metallic pipe 2 is designed to be conductive, with the volume resistivity Rᵥ of the pipeline 1 formed in this way being less than 10⁸ Ωm.

For this purpose, the plastic lining can comprise polyurethane or be made of polyurethane and have a specific surface resistance of less than 8×10⁸ Ωm. Optionally, a metallic insert, such as an expanded metal mesh, can also be arranged in the lining. However, such an insert can also be dispensed with for greater elasticity.

Bulk materials are preferably conveyed through the pipeline 1, for example sand, gravel, grain, soybeans, corn or flour, which have a high abrasive effect when conveyed, wherein the metallic pipe 2 is protected by the inner lining made of plastic. The metallic pipe 2 may have a diameter between 80 and 1000 mm, in particular 150 and 350 mm, the thickness of the metallic pipe 2 being for example 1 mm to 3 mm and the thickness of the lining being for example between 3 mm to 12 mm, in particular 5 mm to 10 mm.

To produce the lining, a preferably plate-shaped material is cut to size and then formed into a tubular body, which is then inserted into the outer metallic pipe 2. The lining 3 is then fixed to the metallic pipe 2 via fastening means 4 and/or adhesives.

To measure the electrostatic chargeability, a metallic tube made of stainless steel with a diameter of 200 mm and a wall thickness of 2 mm was internally covered with a lining made of plastic, which was fixed to the metallic tube via fasteners in the form of screws. The test specimen thus obtained was examined at a relative humidity of 25 to 30% and a temperature of 23° C.

A strip electrode with a length/distance ratio of 10:1 at a measurement voltage of 1000V was placed on the lining in accordance with IEC 60079-32-2:2015 to perform measurements to determine the volume resistivity. The volume resistivity is calculated from the measured volume resistance, the effective electrode area of the strip electrode and the material thickness.

The volume resistivity Rᵥ for different samples ranged from 1.5×10⁶ Ωm to 2.8×10⁶ Ωm, in particular 2.0×10⁶ Ωm and 2.3×10⁶ Ωm. The product of volume resistivity Rᵥ and electrode area ranged from 0.9×10⁴ Ωm² to 1.8×10⁴ Ωm², in particular 1.1×10⁴ Ωm² to 1.6×10⁴ Ωm².

This allows the lined pipeline to be used for conveying combustible dusts, flammable liquids and gases.

### LIST OF REFERENCE NUMERALS

1 Pipeline
2 Pipe
3 Lining
4 Fastening means
d Gap

What is claimed is:

1. A pipeline for conveying fluids or solids, comprising a metallic pipe having an inner wall and a tubular lining made of plastic arranged on the inner wall, wherein a wall structure with the lining and the metallic pipe is configured to be electrically conductive, and a specific volume resistance Rᵥ of the pipeline is less than 10⁸ Ωm.

2. The pipeline according to claim 1, wherein the volume resistance Rᵥ of the pipeline is between 1.5×10⁶ Ωm and 2.8×10⁶ Ωm,

3. The pipeline according to claim 1, wherein the volume resistance Rᵥ of the pipeline is between 2.0×10⁶ Ωm and 2.3×10⁶ Ωm.

4. The pipeline according to claim 1, wherein the lining of plastic comprises a polyurethane, a polyester and/or diphenylmethane.

5. The pipeline according to claim 1, wherein the lining is fixed to the metallic pipe by mechanical fastening means made of metal.

6. The pipeline according to claim1, wherein the lining is bonded to the metallic pipe.

7. The pipeline according to claim 1, wherein the lining is held in a clamping manner in the metallic pipe without mechanical fastening means.

8. The pipeline according to claim 1, wherein the contact force of the lining on the metallic pipe at all measuring points is between 200N and 400N.

9. The pipeline according to claim 1, wherein the lining has a surface resistance between 2×10⁻⁷Ω and 50×10⁻⁷Ω measured with a ring electrode according to EN ISO 284:2004 at a measuring voltage of 1,000 V according to IEC 60079.-32-2:2015.

10. The pipeline according to claim 1, wherein the lining has a thickness in a radial direction of between 3 mm and 10 mm.

11. The pipeline according to claim 10, wherein the lining has a thickness in the radial direction of between 5 mm and 8 mm.

12. The pipeline according to claim 1, wherein an insert made of metal is arranged in the lining.

13. The pipeline according to claim 12, wherein the insert is formed as an expanded metal.

14. The pipeline according to claim 1, wherein the metallic pipe is made of stainless steel.

15. The pipeline according to claim 1, wherein the lining has a specific surface resistance smaller than 8×10⁸Ω.

16. The pipeline according to claim 1, wherein the lining has a contact resistance Rᵥ according to DIN 54345-1:1992 at a measuring voltage of 1,000 V according to IEC 60079-32-2:2015 between 0.5×10⁷Ω and 15×10⁷Ω.
